(19) United States
(12) Patent Application Publication
(10) Pub. No.: US 2002/0141581 A1
(43) Pub. Date: Oct. 3, 2002

(54) Methods and apparatus for attacking a screening algorithm

(75) Inventors: Michael A. Epstein, Spring Valley, NY (US); Martin Rosner, Cortlandt Manor, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 10/109,249

(22) Filed: Mar. 28, 2002

Related U.S. Application Data
(60) Provisional application No. 60/279,639, filed on Mar. 29, 2001.

(51) Int. Cl. H04N 7/167

(52) U.S. Cl. 380/201

(57) ABSTRACT

Methods and apparatus for attacking a screening algorithm. The methods include the steps of searching a medium to determine a location of at least one sample stored on the medium, and applying the sample to content, wherein the content would not pass the screening algorithm but for the application of the sample. Once the locations of the samples are known, the attacker can use the samples to distribute a compressed version of the disk or a song contained on the disk from which the samples are derived, use the samples to import any disk into the SDMI domain, or use the samples to smuggle pirated music into the SDMI domain.

### CROSS REFERENCE TO RELATED APPLICATION

This application claims priority to the U.S. provisional patent application identified by Serial No. 60/279,639, filed on Mar. 29, 2001, the disclosure of which is incorporated by reference herein.

### FIELD OF THE INVENTION

The present invention relates generally to the field of secure communication, and more particularly to techniques for attacking a screening algorithm.

### BACKGROUND OF THE INVENTION

Security is an increasingly important concern in the delivery of music or other types of content over global communication networks such as the Internet. More particularly, the successful implementation of such network-based content delivery systems depends in large part on ensuring that content providers receive appropriate copyright royalties and that the delivered content cannot be pirated or otherwise subjected to unlawful exploitation.

With regard to delivery of music content, a cooperative development effort known as Secure Digital Music Initiative (SDMI) has recently been formed by leading recording industry and technology companies. The goal of SDMI is the development of an open, interoperable architecture for digital music security. This will answer consumer demand for convenient accessibility to quality digital music, while also providing copyright protection so as to protect investment in content development and delivery. SDMI has produced a standard specification for portable music devices, the SDMI Portable Device Specification, Part 1, Version 1.0, 1999, and an amendment thereto issued later that year, each of which are incorporated by reference.

The illicit distribution of copyright material deprives the holder of the copyright legitimate royalties for this material, and could provide the supplier of this illicitly distributed material with gains that encourage continued illicit distributions. In light of the ease of information transfer provided by the Internet, content that is intended to be copy-protected, such as artistic renderings or other material having limited distribution rights, is susceptible to wide-scale illicit distribution. For example, the MP3 format for storing and transmitting compressed audio files has made the wide-scale distribution of audio recordings feasible, because a 30 or 40 megabyte digital audio recording of a song can be compressed into a 3 or 4 megabyte MP3 file. Using a typical 56 kbps dial-up connection to the Internet, this MP3 file can be downloaded to a user's computer in a few minutes. Thus, a malicious party could read songs from an original and legitimate compact disk (referred to herein as a “CD” or a “disk”), encode the songs into MP3 format, and place the MP3 encoded song on the Internet for wide-scale illicit distribution. Alternatively, the malicious party could provide a direct dial-in service for downloading the MP3 encoded song. The illicit copy of the MP3 encoded song can be subsequently rendered by software or hardware devices, or can be decompressed and stored onto a recordable disk for playback on a conventional CD player.

A number of schemes have been proposed for limiting the reproduction of copy-protected content. For example, one scheme for protecting copy-protected content on a compact disk inserts information in the form of inaudible music at the end of the disk. The information is kept inaudible so that it will not be readily detected by a user and it will not be offensive to the user when the user plays the disk. Even if the information is audible, the duration of the information is typically in the range of approximately one or two seconds.

Although the information is inserted on the disk in the form of inaudible music, the information actually contains a screening algorithm for ensuring that the disk is complete. A disk contains digital information which represents music and a sample is some portion thereof. The screening algorithm ensures that the disk is complete by scanning the disk in search of a predetermined number of samples that are strategically stored in various locations on the disk. For example, there may be ten samples stored on the disk at predetermined locations. The digital information in each of the samples can be used to form a digital signature as is known in the art. If a user alters the disk, thereby deleting or changing the location of any one of the ten samples, the algorithm will not recreate the correct digital signature and will reject the disk.

Despite SDMI and other ongoing efforts, existing techniques for secure distribution of music and other content suffer from a number of significant drawbacks. Therefore, prior to adopting any screening approach industry wide, techniques must be identified which would successfully attack and circumvent proposed screening algorithms.

### SUMMARY OF THE INVENTION

The present invention provides apparatus and methods for attacking and circumventing a security screening algorithm, as described herein. In accordance with an aspect of the invention, a method of attacking a screening algorithm includes the steps of searching a medium to determine a location of at least one sample stored on the medium, and applying the sample to content to enable the content to pass the screening algorithm. The medium may be a compact disk which contains music data.

The step of searching the medium preferably includes the steps of downloading the content onto a memory device, replacing a portion of the content with a block of null data and subjecting the content to the screening algorithm. The replacing and subjecting steps are continuously repeated as long as the content passes the screening algorithm. If the content does not pass the screening algorithm, the size of the null data set is reduced and the replacing and subjecting steps are repeated.

The applying step preferably includes the steps of creating a second medium, wherein the content is stored on the second medium, compressing the content on the second medium, distributing the compressed content stored on the second medium to a desired destination, inflating (e.g., decompressing) the compressed content at the desired destination, placing the at least one sample at the determined location on the second medium, and subjecting the content to the screening algorithm.

In accordance with another aspect of the present invention, the applying step includes the steps of receiving the content, overwriting the content with the at least one sample, at the determined location, and subjecting the content to the screening algorithm. When the content is received in compressed format an additional step of inflating the compressed content is necessary. Subsequent to the subjecting step, the at least one sample is removed from the content.

In yet another aspect of the present invention, the applying step includes the steps of placing the at least one sample on a second medium, inserting content within at least one space on the second medium wherein the space is defined by the at least one sample, and subjecting the content to the screening algorithm.

In still yet another aspect of the present invention, an apparatus for attacking a screening algorithm includes a processing device having a processor coupled to a memory. The processing device is operative to search a medium to determine a location of at least one sample stored on the medium, and to apply the at least one sample to content, wherein the content would not pass the screening algorithm but for the application of the sample. The memory stores the content when the content passes through the screening algorithm.

An advantage of the present invention is that it identifies at least one fault in a security screening algorithm. It is through the detection and identification of faults that the underlying screening algorithm can be improved to provide convenient, efficient and cost-effective protection for all content providers.

These and other features and advantages of the present invention will become more apparent from the accompanying drawings and the following detailed description.

### BRIEF DESCRIPTION OF THE DRAWINGS

FIG. 1 is a block diagram illustrating a general overview of the steps of an attack in accordance with the present invention;

FIG. 2A illustrates a uniform distribution of samples within content;

FIG. 2B illustrates a random distribution of samples within content;

FIG. 3 is a flow diagram illustrating a method for identifying sample locations on a disk in accordance with the present invention;

FIG. 4 is a flow diagram illustrating a method for attacking a screening algorithm in accordance with the present invention;

FIG. 5 is a flow diagram illustrating a method for attacking a screening algorithm in accordance with the present invention;

FIG. 6 is a flow diagram illustrating a method for attacking a screening algorithm in accordance with the present invention; and

FIG. 7 is a block diagram illustrating a processing device for use in accordance with an embodiment of the present invention.

### DETAILED DESCRIPTION OF THE INVENTION

The present invention in an illustrative embodiment provides techniques which attack and circumvent screening algorithms that are designed to detect a predetermined digital signature mixed in with the digital content information on a disk. More specifically, the present invention in the illustrative embodiment discloses techniques for attacking the screening algorithm wherein samples used to verify the digital signature are found and utilized to download illicit material.

Advantageously, the invention detects faults in the type of the above-noted security screening algorithm. It is only through the detection and identification of faults that the underlying screening algorithm can be improved to provide convenient, efficient and cost-effective protection for all content providers.

Generally, the above-noted screening algorithm screens a disk in search of a predetermined digital signature on the disk. Once the signature is found, the signature is verified by using a select portion of the data to recreate the digital signature and verify that the data that was signed is unchanged from its original state, as is known in the art. Typically a mathematical one-way function is applied to the data. The result of the mathematical one-way function is compared to the result of applying a public key to the digital signature. If the results are identical, then the signature is valid and the data that was signed is considered to be unchanged. In the scenario presented by the above-noted screening algorithm, only a portion of the data is signed, thereby leaving a path for an attacker. It is impractical in this instance to apply the one-way function to the entirety of the data being verified. Therefore, this and other similar screening algorithms are susceptible to an attack if it is possible for an attacker to discover what subset of the data the digital signature is applied to.

In accordance with an embodiment of the present invention, an attacker has a disk which is known to contain information at the end of the disk regarding a method of screening the disk to confirm that the disk is original. The screening method includes the detection of a digital signature on the disk. The digital signature is made up of a number of individual samples on the disk. Alternatively, a single signature can be formed using all of the samples. Information regarding the specification of the digital signature is also contained within the information that is at the end of the disk, or, alternatively, can be known as part of a standard.

The term “disk” as used herein includes, but is not limited to, compact disks, digital video disks, or other disk-based optical or magnetic storage media.

It is assumed for description of this embodiment that the attacker cannot read the information contained at the end of the disk and does not know where the samples are located on the disk. If the attacker could read the information, then the attacker would presumably know where the samples are and many of the attacker's problems would be solved. Thus, the information at the end of the disk represents the key which would allow the attacker to access the content. However, even if the attacker does not have this key, if the attacker is able to obtain the information regarding the location of the samples, then the attacker will be able to circumvent the screening algorithm.

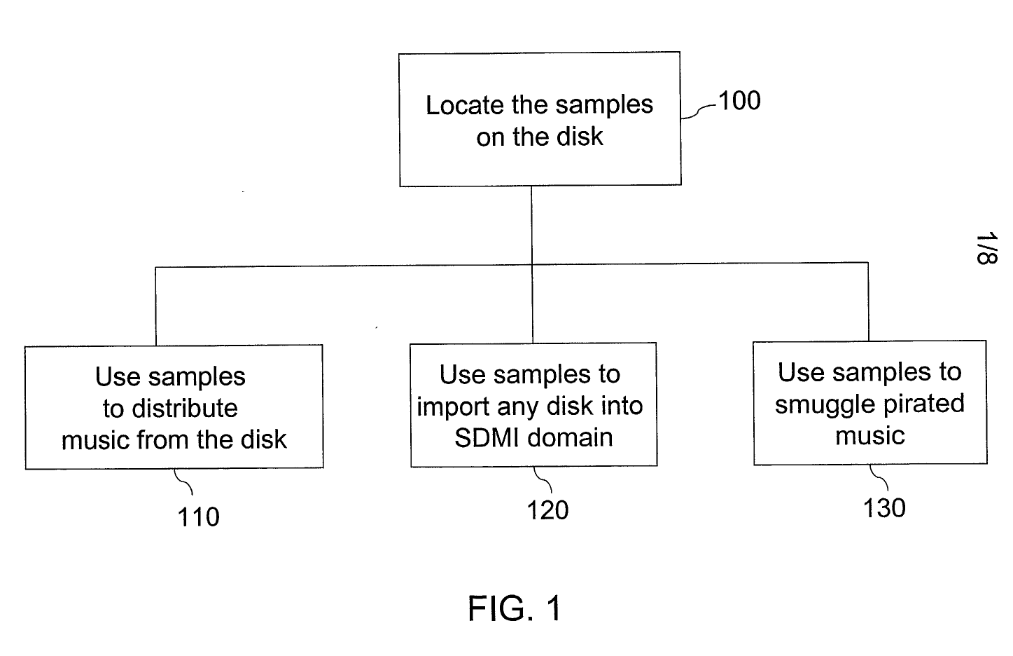

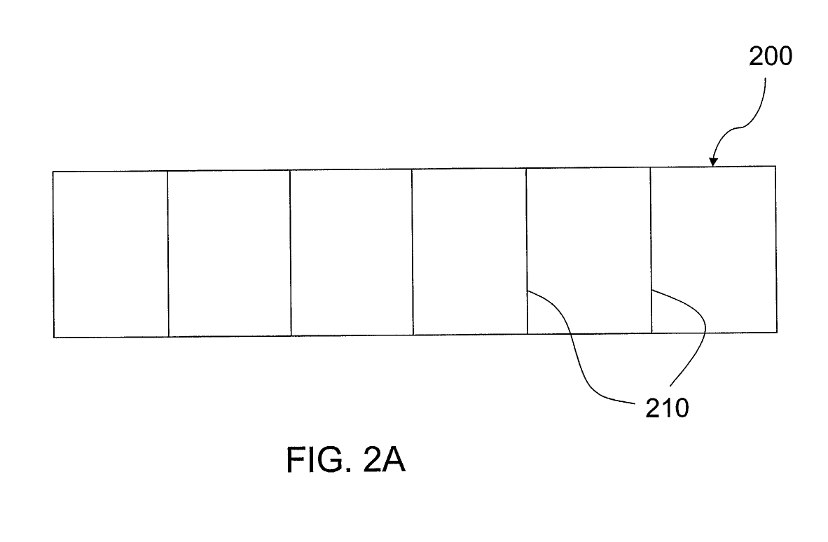

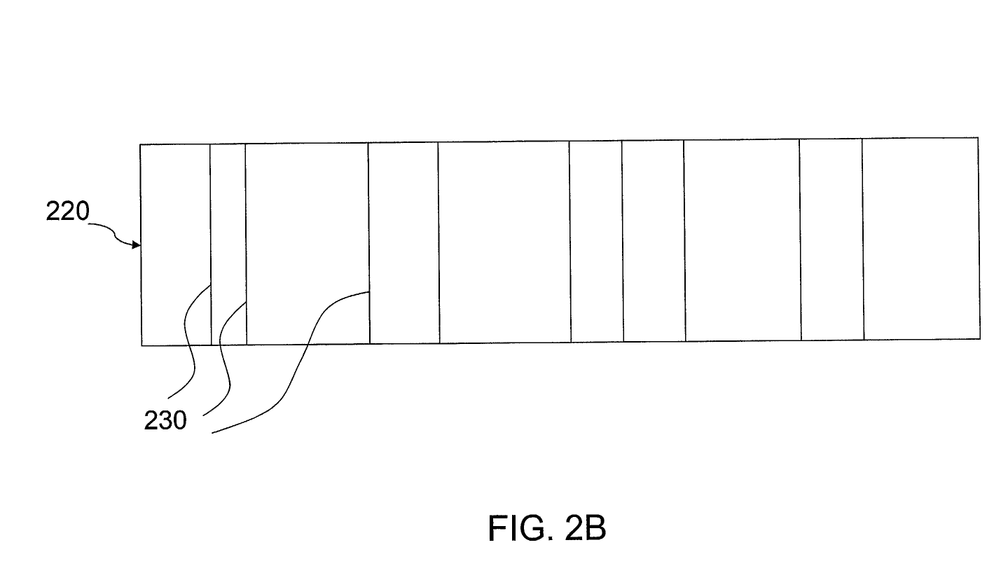

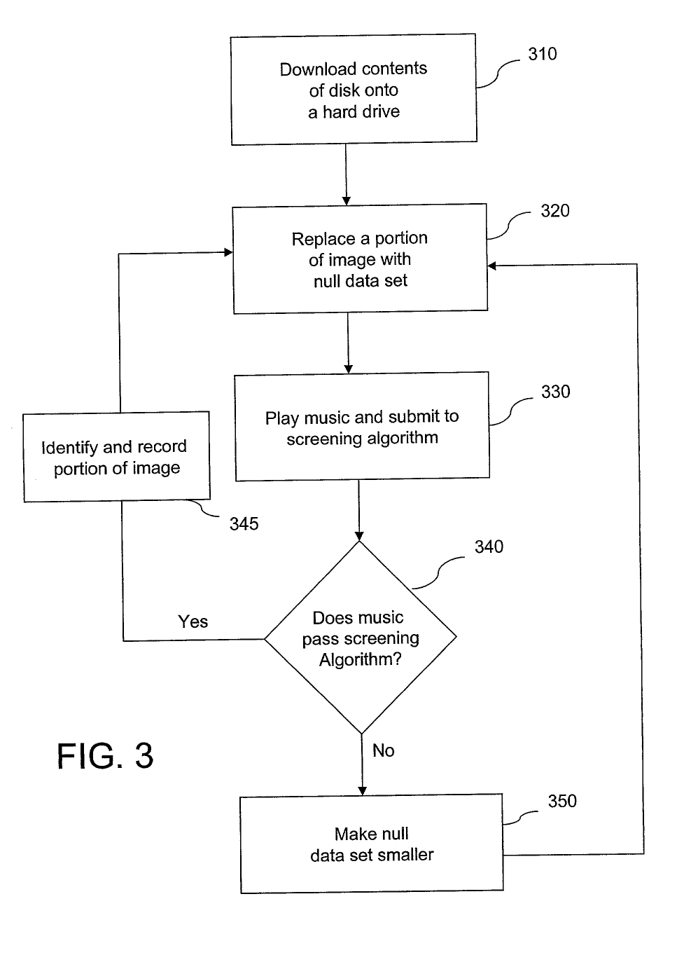

Accordingly, as illustrated in FIG. 1, there are generally two steps to the attack, with the second step having at least three distinct options. In the first step 100, the attacker locates the samples on the disk. The present invention contemplates several methods of locating the samples on the disk. These methods will be described in detail below with reference to FIGS. 2A, 2B and 3.

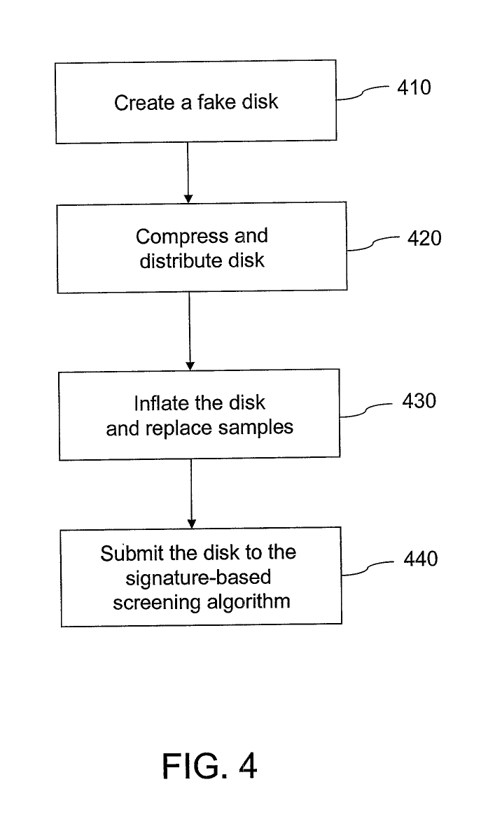

The three example options for the second step are illustrated as steps 110, 120 and 130 in FIG. 1. More specifically, once the locations of the samples are known, the attacker can use the samples to distribute a compressed version of the disk or a song contained on the disk from which the samples are derived, as indicated in step 110, use the samples to import any disk (not just the disk from which the samples are located) into the SDMI domain, as indicated in step 120, or use the samples to smuggle pirated music into the SDMI domain, as indicated in step 130. Each of these methods will be described in detail below with reference to a corresponding one of FIGS. 4, 5 and 6.

Referring now to FIGS. 2A and 2B, there are at least two ways the samples could be distributed within the content on a disk. The first way, illustrated in FIG. 2A, is via a uniform distribution pattern within the content 200. For example, if there are ten samples 210 on a thirty minute disk, the attacker will know that for a uniform distribution pattern the samples 210 will be spaced apart at three minute intervals. In the second type of distribution, illustrated in FIG. 2B, the samples 230 are randomly distributed within the content 220 on the disk. In the random distribution, some of the samples 230 are close together and some are farther apart.

Conceptually, the samples may be viewed as the solid portions of a picket fence and the content between the samples as the voids between the pickets. One goal of the attacker is to find a disk that contains a large void between the pickets. The attacker can utilize that large void to smuggle illicit content into the SDMI domain using method 130. If the samples are uniformly distributed, for example, an attacker may target a classical music CD which is typically long and contains longer tracks than a CD which has other types of music on it. For a seventy-four minute disk with ten uniformly distributed samples, the samples will be spaced 7.4 minutes apart. Therefore, the attacker will be able to conveniently insert any song that is less than 7.4 minutes. If the samples are randomly distributed, some are closer together and some are farther apart, then the attacker may have to review the sample spacing of several disks until one is found that contains a large void.

The methods for identifying the location of samples on a disk will be described below assuming that the samples are randomly distributed. It is clearly more difficult to identify the randomly distributed as compared to the uniformly distributed samples. For example, where the samples are uniformly distributed, when the distribution interval is known, once the location of one sample is determined, the location of all samples will be known. If the distribution interval is not known, then the location of two samples will reveal the location of all samples. Additionally, the procedure used to locate randomly distributed samples may be used to find uniformly distributed samples.

Referring now to FIG. 3, a method for identifying the location of samples on a disk, in accordance with an embodiment of the present invention, will be described. As noted above, it will be assumed that the samples are randomly distributed in this embodiment. The first step 310 is to download the entire contents of a disk onto a memory device such as a hard drive. An image of the disk now resides on the hard drive. The next step 320 is to take a large block of null data and replace a portion of the image on the drive with the null data, thereby effectively erasing part of the image. In step 330, the music is submitted to the screening algorithm. Step 340 determines whether the music passed the screening algorithm. If the music does pass the screening algorithm, it can be assumed that none of the samples are in the particular portions that were covered by the null data set. In step 345, those particular portions are identified and recorded in memory associated with a processing device. The method then returns to step 320 and another portion of the image is replaced with a null data set. This process continues until all of the content without samples is erased from the disk. Eventually, only the samples will remain.

If, in step 340, the music does not pass the screening algorithm, the null data set is made smaller in step 350. There are several ways of reducing the size of the null data set. For example, the null data set may initially be made very large in proportion with the size of the music file, and then the null data set is subsequently reduced in half several times e.g., a binary search approach is utilized. Alternatively, the null data set begins as a predetermined minimal size, and it is then doubled in size. As another example, the null data set may begin at a fixed size such as, for example, 100 units, where, e.g., one unit is equal to one second. If that size yields positive results, the size can then be increased to 200 units. If positive results are not achieved at 200 units, the size may be reduced to 50 units. If that size works, 25 units may be either added or subtracted. Eventually, the size of the null data set will be such that a sample will exist on the leading edge of the portion of the image to be replaced by the null data set. In this case, if one more unit is added to the null data set, then the data set will erase at least a part of the sample and the disk will not pass the screening algorithm. Once a sample location is determined, it is recorded, e.g., in memory associated with a processing device that may be used to implement a software program in accordance with the present invention. The search is then performed again to determine the next location, while skipping the known locations.

Additionally, for random samples, one-half of the image may be replaced by a null data set and the remaining half submitted to the screening algorithm. If the half of the image submitted to the screening algorithm passes the screening algorithm, then it is safe to assume that the samples are in that half and not the other half. If the half of the image submitted to the screening algorithm does not pass the screening algorithm, then one of the samples was in the half replaced by the null data set, and the set can be reduced in size to cover only one-quarter of the image. The size of the null data set is continuously reduced until the exact location and size of the sample is determined. Once the first sample is located, the process is started over again.

Certain signature-based screening algorithms are designed to account for the inherent slippage associated with playing a disk. For example, slippage might alter the location of a sample by plus or minus twenty-five units. Therefore, the method in accordance with an embodiment of the present invention will preferably emulate the slippage of the disk when searching for the exact location of the sample. If precautions are not taken to emulate the slippage of the disk, then the content may pass the screening algorithm, or fail the screening algorithm, without the attacker knowing the exact location of the sample. Thus, when determining the location of the sample, the attacker will preferably take a substantial number of trials, e.g., fifty plus or minus twenty-five trials.

However, if a hard drive is used to emulate the disk, there will generally not be any slippage. Therefore, emulation of mechanical slippage is not always required.

If the null data set was made the size of one sample, and was incremented one unit at a time, the sample would eventually be covered and the disk would be denied access to the SDMI domain by the screening algorithm. However, in a situation in which the above-noted slippage emulation is implemented, each increment could take fifty or more trials to emulate the slippage.

FIG. 4 is a flow diagram illustrating a method for attacking a signature-based screening algorithm in accordance with another embodiment of the present invention. In this embodiment, when an attacker desires to distribute compressed music, the attacker obtains a copy of the content which he/she desires to distribute and creates a fake disk in step 410. In step 420, the fake disk is then compressed and distributed over the Internet, for example. The compressed disk and the samples and table of contents (TOC) are sent to the desired destination. At the destination, the compressed disk is inflated and the samples are placed in the correct location overwriting the inflated content, in step 430. In step 440, the disk is submitted to the signature-based screening algorithm. It is highly probable that the disk will pass the screening algorithm, since the appropriate signature data will exist in the appropriate location.

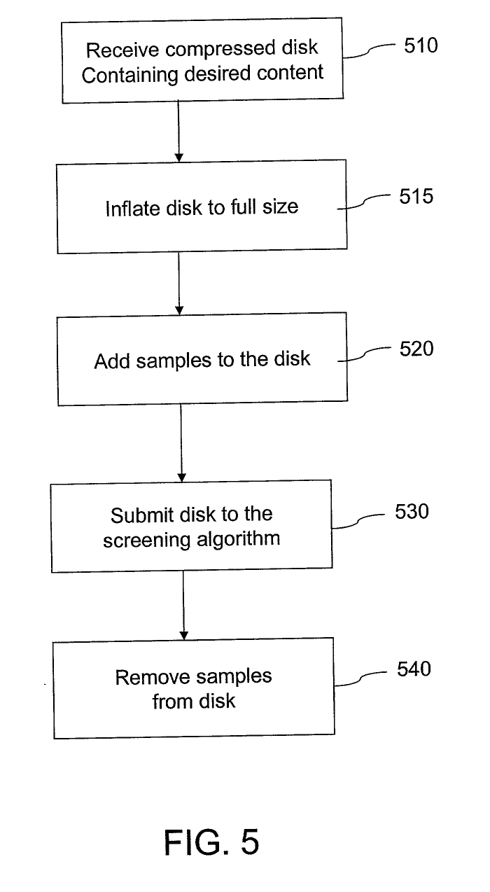

Referring now to FIG. 5, in accordance with another embodiment of the present invention, by utilizing the information regarding the digital signature, samples and table of contents from one disk, any disk or song may be imported into the SDMI domain. The first step 510 is to receive a compressed disk which contains the content to be imported into the SDMI domain. In step 515 the disk is inflated to full size. The samples are then added onto the disk in the proper locations according to the digital signature in step 520, overwriting the corresponding inflated music. The samples on the disk may disturb the disk or song(s) that are being downloaded. The disk will then be submitted to the screening algorithm in step 530. The disk is expected to pass the screening algorithm, since each of the samples is in the location dictated by the digital signature. In step 540, once inside the SDMI domain, the samples may be removed and the disk will be restored to its original condition. Alternatively, interpolated music may be substituted in place of the samples.

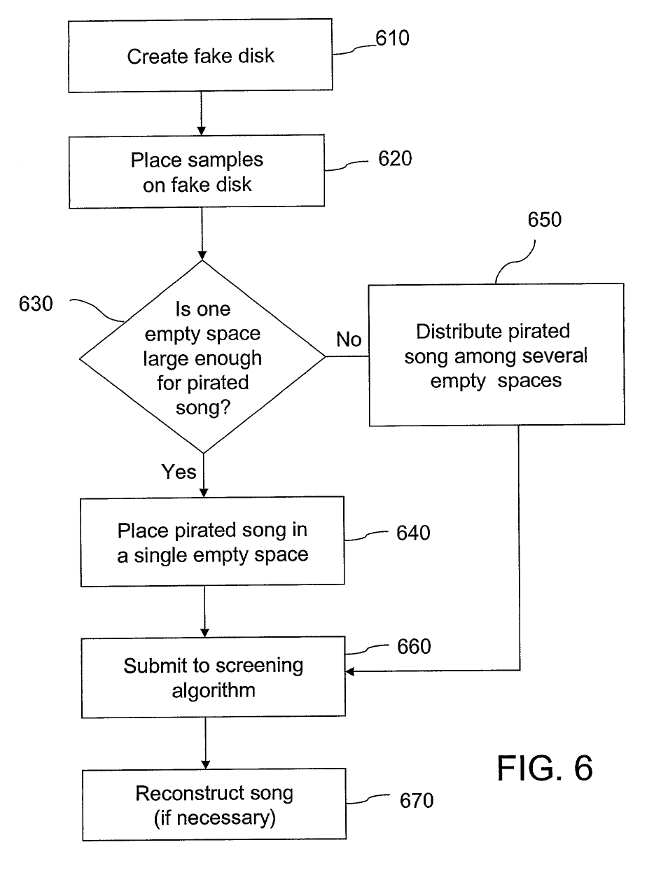

FIG. 6 illustrates another embodiment of the present invention wherein pirated music is smuggled into the SDMI domain utilizing the sample information. To smuggle a single song in, a fake disk is made in step 610 and, in step 620, the samples are placed on the fake disk in the proper positions, in accordance with the digital signature. Between the samples are intervals of empty space, each interval defined by a corresponding pair of the samples. In step 630, the empty spaces are analyzed to determine the size of the space. If a single empty space is large enough, an entire song may be placed therein, in step 640. This song may be retrieved in compressed or uncompressed form from the Internet and inflated to its original size, if necessary. If there are no single empty spaces which are large enough to house an entire song, the song is broken up into several pieces and stored in a plurality of empty spaces, in step 650. The disk will then be submitted to the screening algorithm in step 660. The disk is expected to pass the screening algorithm, since each of the samples is in the location dictated by the digital signature. The screening algorithm is only concerned with the proper location of the samples and is not concerned with the information between the samples. The song can then be reconstructed again, in step 670, after it is in the SDMI domain.

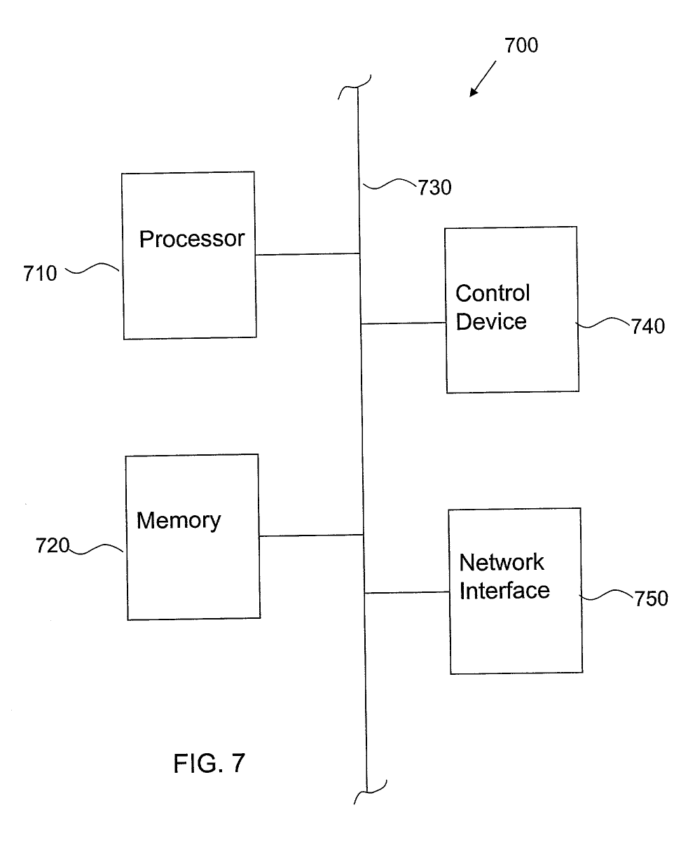

FIG. 7 shows an example of a processing device 700 that may be used to implement, e.g., a software program in accordance with the present invention for attacking a screening algorithm. The device 700 includes a processor 710 and a memory 720 which communicate over at least a portion of a set 730 of one or more system buses. Device 700 also utilizes at least a portion of the set 730 of system buses which is connected to a control device 740 and a network interface device 750. The device 700 may represent, e.g., any type of processing device for use in implementing at least a portion of the above-described processes in accordance with the present invention. The elements of the device 700 may correspond to conventional elements of devices such as computers, personal digital assistants (PDAs), digital music players, etc.

For example, the processor 710 may represent a microprocessor, central processing unit (CPU), digital signal processor (DSP), or application-specific integrated circuit (ASIC), as well as portions or combinations of these and other elements of conventional processing devices. The memory 720 is typically an electronic memory, but may comprise or include other types of storage devices, such as disk-based optical or magnetic memory.

As indicated previously, the techniques described herein may be implemented in whole or in part using software stored and executed using the respective memory and processor elements of the device 700. For example, the invention may be implemented at least in part using one or more software programs stored in memory 720 and executed by processor 710. The particular manner in which such software programs may be stored and executed in device elements such as memory 720 and processor 710 is well understood in the art and therefore not described in detail herein.

It should be noted that the device 700 may include other elements not shown, or other types and arrangements of elements capable of providing the functions described herein.

The above-described embodiments of the invention are intended to be illustrative only. Although the present invention is described with reference to a particular signature-based screening algorithm, the present invention may be applied to other screening algorithms. Although the present invention is illustrated with reference to music compact disks, the invention is not limited to use in that context. These and numerous other embodiments within the scope of the following claims will be apparent to those skilled in the art.

What is claimed is:

1. A method of attacking a screening algorithm, the method comprising the steps of:
searching a medium to determine a location of at least one sample stored on the medium; and
applying the at least one sample to content, wherein the content would not pass the screening algorithm but for the application of the sample.

2. The method as recited in claim 1, wherein the medium is a compact disk.

3. The method as recited in claim 1, wherein the medium contains music data.

4. The method as recited in claim 1, wherein the at least one sample represents at least a portion of a digital signature.

5. The method as recited in claim 1, wherein the searching step comprises the steps of:
downloading the content onto a memory device;
replacing a portion of the content with a block of null data; and
subjecting the content to the screening algorithm.

6. The method as recited in claim 5, wherein the memory device is a hard drive.

7. The method as recited in claim 5, wherein the replacing and subjecting steps are repeated if the content passes the screening algorithm.

8. The method as recited in claim 7, wherein the replacing and subjecting steps are continuously repeated as long as the content passes the screening algorithm.

9. The method as recited in claim 8, further comprising the step of identifying samples within the content wherein the samples are those portions of the content which when covered by the null data set cause the content to not pass the screening algorithm.

10. The method as recited in claim 5, further comprising the step of reducing a size of the null data set if the content does not pass the screening algorithm.

11. The method as recited in claim 10, wherein the replacing and subjecting steps are repeated, subsequent to the step of reducing the size of the null data set.

12. The method as recited in claim 1, wherein the applying step comprises the steps of:
creating a second medium, wherein the content is stored on the second medium;
compressing the content on the second medium;
distributing the compressed content stored on the second medium to a desired destination;
inflating the compressed content at the desired destination;
placing the at least one sample at the determined location on the second medium; and
subjecting the content to the screening algorithm.

13. The method as recited in claim 12, wherein the at least one sample overwrites the content during the placing step.

14. The method as recited in claim 1, wherein the applying step comprises the steps of:
receiving the content;
overwriting the content with the at least one sample, at the determined location; and
subjecting the content to the screening algorithm.

15. The method as recited in claim 14, wherein the content is received in compressed format.

16. The method as recited in claim 15, further comprising the step of inflating the compressed content subsequent to the content being received in compressed format.

17. The method as recited in claim 14, further comprising the step of:
removing the at least one sample from the content subsequent to the subjecting step.

18. The method as recited in claim 1, wherein the applying step comprises the steps of:
placing the at least one sample on a second medium;
inserting content within at least one space on the second medium wherein the space is defined by the at least one sample; and
subjecting the content to the screening algorithm.

19. An apparatus for attacking a screening algorithm comprising:
a processing device having a processor coupled to a memory, the processing device being operative to search a medium to determine a location of at least one sample stored on the medium; and to apply the at least one sample to content, wherein the content would not pass the screening algorithm but for the application of the sample, and the memory storing at least a portion of the content when the content passes through the screening algorithm.

20. An article of manufacture for attacking a screening algorithm, the article comprising a machine readable medium containing one or more programs which when executed implement the steps of:
searching a medium to determine a location of at least one sample stored on the medium; and
applying the at least one sample to content, wherein the content would not pass the screening algorithm but for the application of the sample.
